(19) United States
(12) Patent Application Publication
(10) Pub. No.: US 2024/0215493 A1
(43) Pub. Date: Jul. 4, 2024

(54) SEMI-TRAILER CARRYING DUMP MULE

(71) Applicant: Silonz LLC, Brook, IN (US)

(72) Inventor: Kyler Laird, Rensselaer, IN (US)

(73) Assignee: Silonz LLC, Brook, IN (US)

(21) Appl. No.: 18/584,125

(22) Filed: Feb. 22, 2024

Related U.S. Application Data
(63) Continuation of application No. PCT/US22/75322, filed on Aug. 23, 2022.
(60) Provisional application No. 63/260,497, filed on Aug. 23, 2021.

(51) Int. Cl. A01D 90/10; A01D 90/16; B60J 5/10; B60J 7/06; B60P 1/04; B60P 1/42; B60P 3/24; B60S 9/02; B62D 33/04; B62D 61/12; B62D 63/08; E05F 15/70

(52) U.S. Cl. CPC A01D 90/10; A01D 90/16; B60J 5/108; B60P 1/42; B60S 9/02; B62D 61/12; B62D 63/08; B60J 7/06; B60P 1/04; B60P 3/24; B62D 33/04; E05F 15/70; E05Y 2900/516

(57) ABSTRACT

A crop harvesting system for reducing compaction includes a dump mule and a trailer. The dump mule is an autonomous vehicle configured to automatically hook and drop the trailer. The mule includes one or more wheels and a conveyor system configured to transport crops from the trailer into an auger for loading. The trailer includes a set of automatic landing gear, one or more hoppers, an automatic tarp system, and two or more retractable wheels. In an example use case, the mule commands the trailer to raise the landing gear as the mule positions underneath the trailer. In one embodiment, once the trailer is properly positioned on the mule, the mule commands the trailer to raise the wheels. At this stage, the mule bears the full weight of the trailer. From here, the mule transports the trailer to a crop storage system to empty the trailer via the auger.

### CROSS REFERENCE TO RELATED APPLICATIONS

This application is a continuation of International Patent Application Number PCT/US2022/075322, filed Aug. 23, 2022, which is hereby incorporated by reference. International Patent Application Number PCT/US2022/075322, filed Aug. 23, 2022, claims the benefit of U.S. Patent Application No. 63/260,497, filed Aug. 23, 2021, which are hereby incorporated by reference.

### BACKGROUND

To harvest crops, farmers typically utilize large agricultural vehicles, such as combines, tractors, and trailers. However, trailers are typically not properly equipped for over soil travel. This leads to an increase in soil compaction. Soil compaction reduces crop yield through poor water and nutrient intake.

Thus, there is a need for improvement in this field.

### SUMMARY

A unique crop harvesting system including a vehicle and a trailer has been developed to reduce soil compaction. In one embodiment, the vehicle includes a standard wheel and tire arrangement. In another embodiment, the vehicle includes a continuous track propulsion system. The continuous track system distributes a vehicle weight over an increased surface area. As should be appreciated, distributing the vehicle weight reduces soil compaction. The vehicle further includes a hitch configured to receive a trailer. In one aspect, the hitch is a fifth wheel type hitch. In another aspect, the trailer is a standard semi-trailer. In a further aspect, the trailer is a hopper type trailer.

The fifth wheel hitch is configured to distribute a trailer load weight evenly onto the vehicle to decrease compaction. The hitch includes an automatic actuator to hook and drop the trailer from the vehicle. In one example, the hitch further includes one or more sensors. The sensors are configured to monitor the hook and drop process to confirm completion. The trailer includes modified automatic landing gear. The landing gear is configured to extend when uncoupled from a vehicle and retract when coupled to a vehicle. In one embodiment, the landing gear is configured with a large landing foot. The large landing foot increases surface area to decrease soil compaction. The trailer braking system is self-contained. Meaning, the trailer braking system is not connected to the braking system of the vehicle. In one example, the trailer braking system includes an air tank, an electric pump, a battery, and a solenoid valve. The solenoid valve is configured to control a parking brake release through wireless communication with the vehicle. The wireless communication is a short-range wireless communication protocol. In one example, the wireless communication protocol is Bluetooth. The trailer braking system is configured to activate when the landing gear is extended to prevent activation on the road. In one example, the trailer includes Department of Transportation (DOT) approved high-flotation tires and a central tire inflation system (CTIS). The CTIS allows the tires to be deflated when on soil to mitigate compaction and inflated when on the road to minimize friction and increase fuel savings.

In some examples, a wireless network is configured to control various aspects of the vehicle and trailer. For example, the wireless network is configured to control the operation of a tarp covering the trailer. In another example, the wireless network is configured to transmit a video feed of the trailer to an operator. In a further example, the wireless network is configured to control trailer lighting. In yet another example, the wireless network is configured to send trailer position data to the vehicle from Global Positioning System (GPS) components located on the trailer. The position data from the trailer is used by the vehicle to facilitate an automated process whereby the vehicle drops off a loaded trailer, connects to the wireless network of an empty trailer, and uses the position data to properly hook and remove an empty trailer.

In one example, the vehicle is attached to a combine with a tow arm and towed to the field. In a second example, the tow arm includes one or more sensors. The sensors direct the vehicle to follow the path of the combine under the power of the vehicle. Once the operator has reached the crop area, the vehicle is disconnected from the tow arm and the tow arm is stowed under the vehicle. To facilitate communication, the vehicle is connected to the combine wirelessly via a dongle connected to an International Organization for Standardization (ISO) bus/diagnostic port of the combine. The wireless connection is configured to exchange information about the harvested area, the current yield, and the remaining storage space inside the combine. In one example, the wireless connection is a long-range wireless network.

As the combine reaches storage capacity, the vehicle moves into position to accept a load from the combine. As the vehicle moves to intercept the combine, the tarp over the trailer automatically opens to receive the load. Once the vehicle is properly positioned, a command is sent to the combine. The command instructs the combine to empty the crop storage into the trailer. In one form, the combine uses on-the-go dumping in which the combine continues harvesting during the loading or unloading process. For example, an auger arm of the combine swings out over the vehicle while the combine continues to harvest. During the loading process, the vehicle shifts to allow for loading towards the front of the trailer first. The shifting process keeps weight over the tracks and/or wheels of the vehicle to aid in traction control. In one embodiment, the trailer includes one or more load sensors in the suspension. In another embodiment, the trailer includes one or more load sensors in the fifth wheel hitch. The load sensors are configured to monitor the weight of the crops that are loaded into the trailer. The weight data is used to adjust the position of the vehicle. As was discussed above, the position of the vehicle is based upon balancing the trailer weight. In another example, the trailer further includes one or more paddle sensors. The paddle sensors are configured to monitor the height of the crops in the trailer. In one example, the sensors send an alert to the vehicle that the crops have reached a predetermined fill level.

After the trailer is filled, the vehicle transmits a command to the combine to stop loading, pull away, and resume harvesting. If the trailer is full, the vehicle returns to a loading area. As the vehicle moves towards the loading area, the trailer begins to automatically close the tarp to protect the crops. Once the vehicle reaches the loading area, the vehicle activates the landing gear of the trailer, activates the parking brakes of the trailer, and automatically disconnects from the trailer.

In another embodiment, the crop harvesting system includes a vehicle, commonly referred to as a mule, detachably coupled to the trailer. In one example, the trailer is an on-road compatible semi-trailer with a pivotable rear door for crop unloading. In another example, the trailer includes a dump hoist. The mule is configured to lift and fully support the weight of the trailer to prevent trailer ground contact. Most semi-trailers and other road-based trailers are not designed for travelling across farm fields. The wheels of the trailer can compact the soil and even become stuck in mud. By lifting and carrying the trailer across the farm field to combine, the vehicle or mule can avoid these as well as other issues.

In one example, the mule is an autonomous vehicle including a trailer support system. The trailer support system is configured to slide underneath the trailer during pickup guided by one or more sensors, channels, and/or rollers. In another example, the trailer includes automatic landing gear and/or automatically retracting wheels. To facilitate trailer drop-off and pick-up, the landing gear is configured automatically extend and retract upon detection of the mule. For example, during trailer pickup, the landing gear detects the approaching mule and automatically retracts underneath the trailer. In another example, the landing gear is configured to automatically retract after the trailer latches into a fifth wheel hitch on the mule. Retracting the landing gear clears space to allow the mule to continue to back further under the trailer. For example, as the mule backs under the trailer one or more trailer lift arms of the mule engage one or more rails of the trailer to guide the trailer onto the mule. Simultaneously, the fifth wheel hitch slides along one or more trailer guides via casters. In one embodiment, once the mule reaches the trailer wheels, the mule locks into the trailer and the trailer wheels are retracted. As should be appreciated, after the trailer wheels are retracted the trailer is fully supported by the mule. In another embodiment, once the mule reaches the trailer wheels, the mule pivots such that the trailer wheels are raised above the ground. Put differently, the trailer is said to be “floating” (e.g. not in contact with the ground) to reduce soil compaction.

In one example, the mule is configured to carry the trailer into the field to collect crops from the combine. In another example, the mule is configured to pick-up and empty trailers that have already been filled and are deposited at a “dump depot.” The trailer includes one or more load sensors configured to monitor the weight of the crops that are loaded into the trailer. The weight data is used to adjust the position of the mule. The position of the mule is based upon balancing the trailer weight. In another example, the trailer further includes one or more moisture sensors. The moisture sensors are configured to monitor the moisture content of the harvested crops. In one example, the moisture content and crop weight are used to calculate an expected crop yield.

After the trailer is full, the mule pulls away from the combine and drives to an unloading area. As the mule drives to the unloading area, an automatic tarp is deployed to “seal” the crop load. In one example, the trailer includes one or more sensors located on the tarp and/or trailer rear door. The one or more sensors are configured to detect the position of the tarp and/or rear door. In another example, the one or more sensors are configured to detect tampering with the crop load.

In one embodiment, once arriving in the unloading area, the mule extends the trailer wheels, unlocks from the trailer, and drives out from underneath the trailer. As the mule drives out from underneath the trailer the landing gear is automatically extended. To enable trailer locating tracking, the trailer includes a Global Positioning System (GPS) configured to monitor the status and location of the trailer. In another embodiment, the mule includes a hitch with one or more attachment arms. In one example, the hitch is configured to connect with a grain bagger. For example, the mule is configured to automatically connect with the grain bagger and begin to transfer grain from the trailer into the grain bagger via a conveyor system within the mule.

The system and techniques as described and illustrated herein concern a number of unique and inventive aspects. Some, but by no means all, of these unique aspects are summarized below.

Aspect 1 generally concerns a system that includes a harvesting system.

Aspect 2 generally concerns the system of any previous aspect including a trailer.

Aspect 3 generally concerns the system of any previous aspect in which the trailer configured to collect harvested crops.

Aspect 4 generally concerns the system of any previous aspect in which the trailer is configured to collect harvested crops from a combine.

Aspect 5 generally concerns the system of any previous aspect in which the trailer includes a moisture sensor configured to detect a moisture content of the crops.

Aspect 6 generally concerns the system of any previous aspect in which the trailer has landing gear and a motor configured to automatically extend and retract the landing gear upon detection of the vehicle.

Aspect 7 generally concerns the system of any previous aspect in which the landing gear includes one or more large-footprint pads configured to prevent trailer sinking.

Aspect 8 generally concerns the system of any previous aspect in which the trailer includes one or more retractable wheels.

Aspect 9 generally concerns the system of any previous aspect in which the wheels are configured to retract after the trailer is hooked to the vehicle to reduce compaction.

Aspect 10 generally concerns the system of any previous aspect in which the trailer includes an automatic tarp system configured to open and close based on commands from the vehicle.

Aspect 11 generally concerns the system of any previous aspect in which the trailer includes one or more sensors configured to detect tarp position.

Aspect 12 generally concerns the system of any previous aspect in which the trailer includes a rotating rear door for crop removal.

Aspect 13 generally concerns the system of any previous aspect in which the trailer includes one or more sensors configured to detect rear door position.

Aspect 14 generally concerns the system of any previous aspect in which the trailer includes a dump hoist for crop removal.

Aspect 15 generally concerns the system of any previous aspect in which the trailer includes an on-board controller configured to monitor the door sensors and tarp sensors to detect load tampering.

Aspect 16 generally concerns the system of any previous aspect in which the trailer includes a Real-time Kinematic Positioning Global Positioning System (RTK GPS).

Aspect 17 generally concerns the system of any previous aspect in which the RTK GPS is configured to use the trailer as a base station for sending real-time corrections to the vehicle.

Aspect 18 generally concerns the system of any previous aspect in which the trailer includes one or more electrically controlled grain hoppers configured to open and close based on commands from the vehicle.

Aspect 19 generally concerns the system of any previous aspect including a combine.

Aspect 20 generally concerns the system of any previous aspect in which the combine includes harvesting machine that heads, threshes, and/or cleans grain while moving over a field.

Aspect 21 generally concerns the system of any previous aspect including a vehicle.

Aspect 22 generally concerns the system of any previous aspect in which the vehicle is detachably coupled to the trailer to move the trailer.

Aspect 23 generally concerns the system of any previous aspect in which the vehicle includes a hitch.

Aspect 24 generally concerns the system of any previous aspect in which the vehicle is at least a level 4 autonomous vehicle configured autonomously move the trailer to and from the combine.

Aspect 25 generally concerns the system of any previous aspect in which the vehicle is configured to fully support the weight of the trailer to prevent trailer ground contact.

Aspect 26 generally concerns the system of any previous aspect in which the vehicle includes a flat-bed type trailer support system configured to slide beneath the trailer during an autonomous trailer hooking and dropping process.

Aspect 27 generally concerns the system of any previous aspect in which the vehicle and trailer include one or more sensors, channels, and/or rollers configured to facilitate autonomous hooking and dropping of the trailer.

Aspect 28 generally concerns the system of any previous aspect in which the vehicle includes a load sensor configured to detect a loading pattern of the crops in the trailer.

Aspect 29 generally concerns the system of any previous aspect in which the vehicle includes a conveyor system configured to receive grain from the hoppers and transport grain throughout the vehicle.

Aspect 30 generally concerns the system of any previous aspect in which the vehicle includes an auger configured to automatically transport grain from the conveyor system into a grain bagger.

Aspect 31 generally concerns the system of any previous aspect in which the vehicle and trailer communicate via telemetry to control the automatic hooking and dropping and automatic fill of the grain bagger.

Aspect 32 generally concerns the system of any previous aspect in which the harvesting system having a trailer configured to collect harvested crops from a combine and a vehicle detachably coupled to the trailer to move the trailer.

Aspect 33 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a dump mule carrying a trailer.

FIG. 2 is a perspective view of the dump mule carrying the trailer of FIG. 1.

FIG. 3 is a front view of the dump mule carrying the trailer of FIG. 1.

FIG. 4 is a side view of the trailer of FIG. 1.

FIG. 5 is a perspective view of the dump mule of FIG. 1.

FIG. 6 is a perspective view of the dump mule of FIG. 5 without wheels.

FIG. 7 is a perspective view of the dump mule of FIG. 5 without wheels.

FIG. 8 is a top view of the dump mule of FIG. 5 without wheels.

FIG. 9 is a rear view of the dump mule of FIG. 5 without wheels.

FIG. 10 is a side view of a trailer loading event.

FIG. 11 is a front view of the trailer loading event of FIG. 10.

FIG. 12 is a side view of the trailer loading event of FIG. 10.

FIG. 13 is a side view of a crop unloading event.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

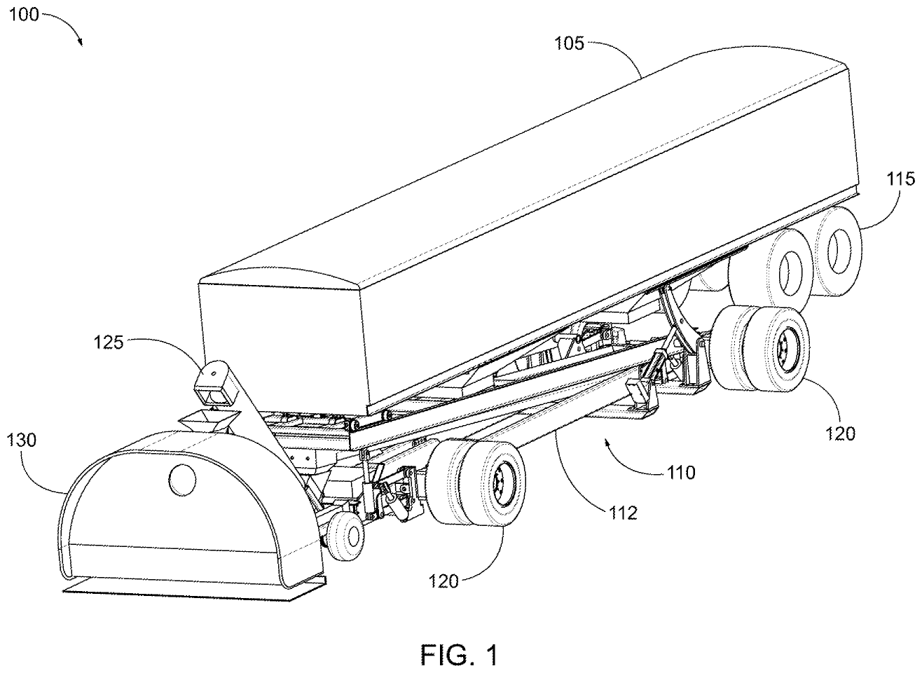

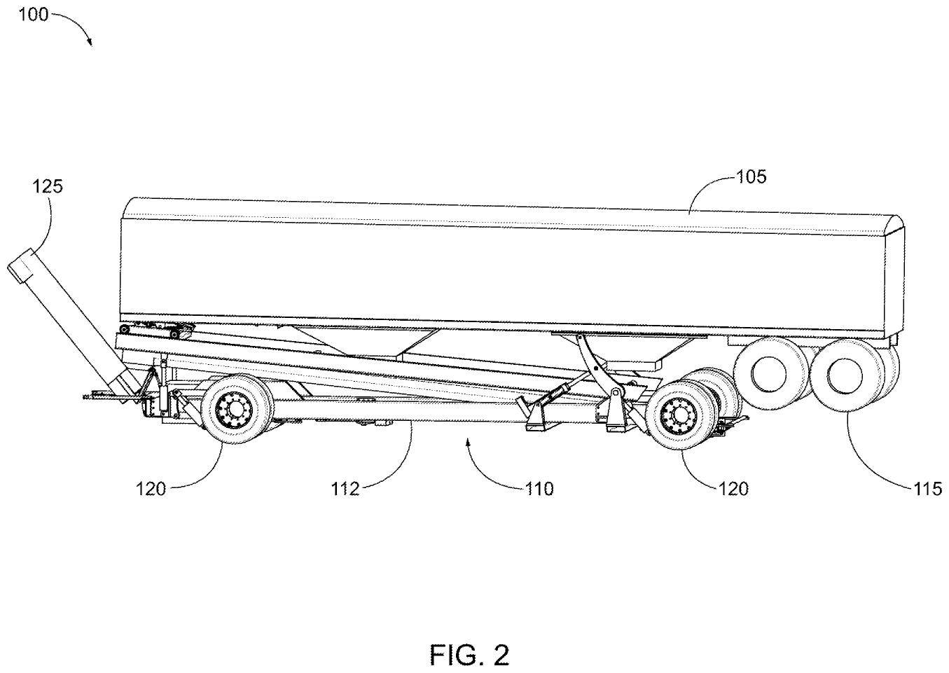

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

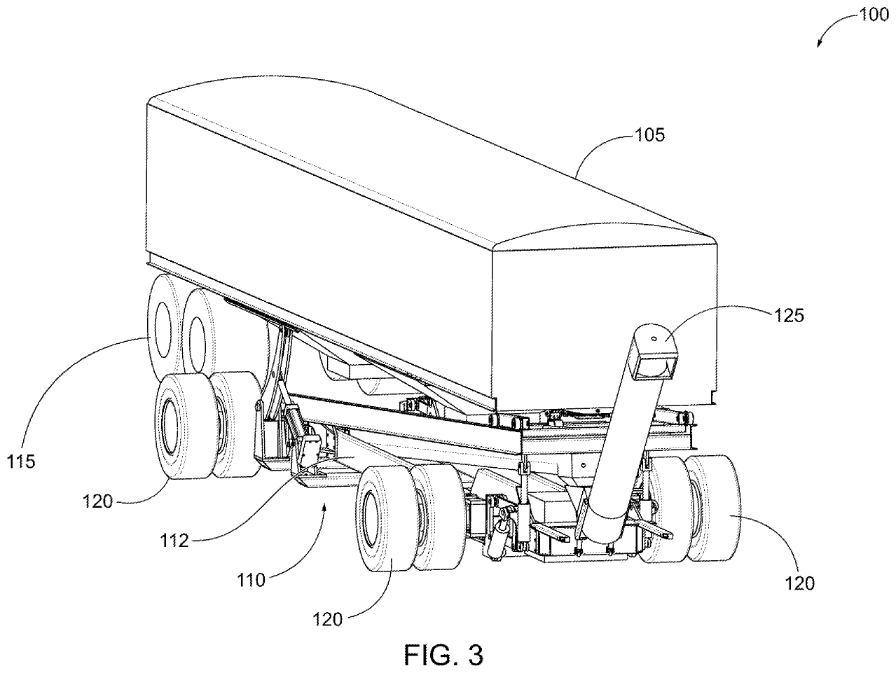

FIGS. 1, 2, and 3 show an example of a harvest transport system 100. The harvest transport system 100 includes a trailer 105 and a vehicle 110, commonly referred to as a mule 112. The trailer 105 includes one or more trailer wheels 115. The vehicle 110 or mule 112 has one or more mule wheels 120 and an auger 125. The auger 125 is configured to transport and/or unload crops from the trailer 105 into a grain bagger 130. In one example, the auger 125 is removable from the mule 112. As can be seen, the mule 112 supports the entire weight of the trailer 105, such that the trailer wheels 115 are “floating” above the ground. As should be appreciated, this configuration reduces ground compaction caused by trailer wheels. Additionally, the use of a driverless mule 112 enables the automated transfer of harvested crops from the field to the grain bagger 130.

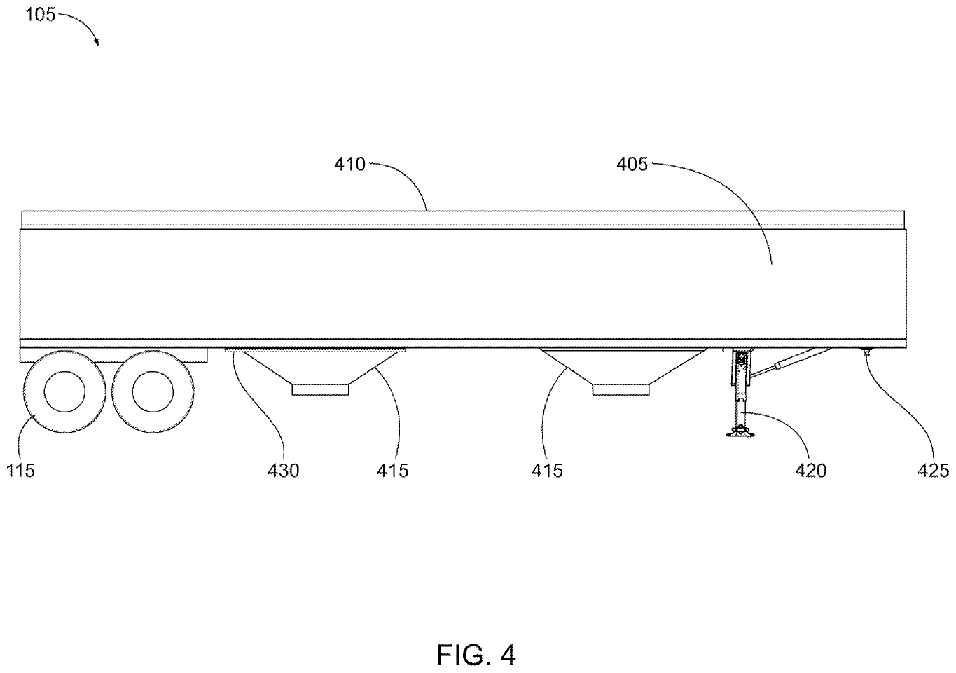

FIG. 4 shows an example of the trailer 105. The trailer 105 includes a body 405, a tarp 410, and one or more hoppers 415. In some examples, the trailer 105 includes automatic landing gear 420. The trailer wheels 115, tarp 410, hoppers 415, and landing gear 420 are all configured to work automatically based on wireless communication between the trailer 105 and the vehicle 110. For example, the mule 112 is configured to issue commands to the trailer 105 so as to automatically retract and/or deploy the landing gear 420 of the trailer 105. The mule 112 further issues commands to the trailer 105 for automatically retracting or deploying the trailer wheels 115. The mule 112 also communicates with the trailer 105 so as to automatically open or close the hoppers 415. Similarly, the trailer 105 can automatically open and close the tarp 410 based on a fill level of the trailer 105.

The trailer 105 additionally includes a kingpin 425 configured to interact and/or latch within a fifth wheel style hitch as will be described in greater detail later. In one embodiment, the trailer 105 includes one or more reinforced guide rails 430 configured to enable a lift mechanism to lift the trailer 105 without damaging the trailer 105. In one example, the guide rails 430 extend along the entire length of the trailer 105. In another example, the guide rails 430 extend along only a portion of the trailer 105.

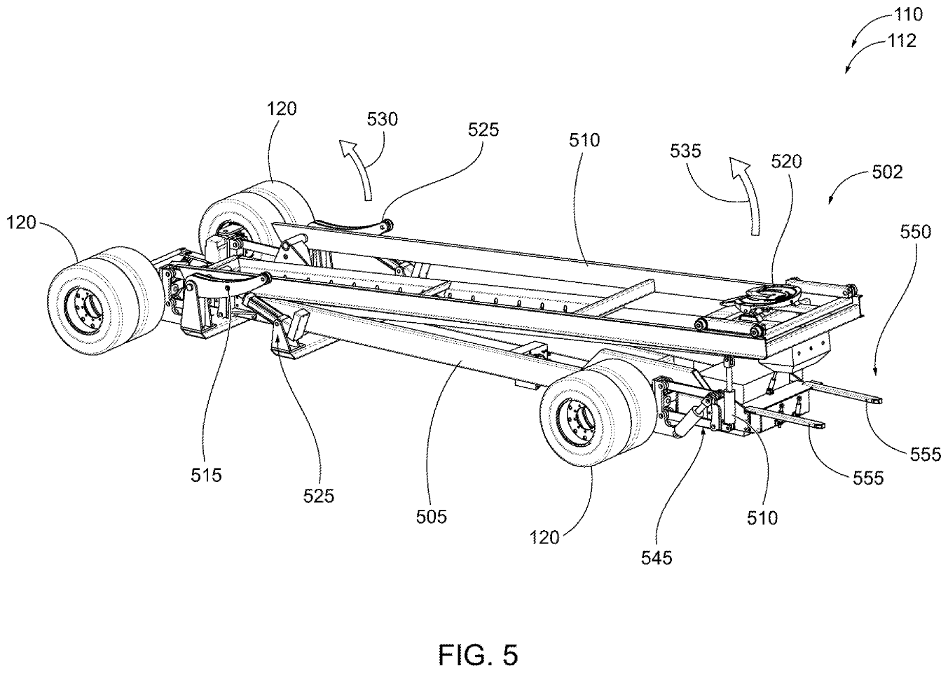

FIG. 5 shows an example of the mule 112 including the mule wheels 120. In other embodiments, the mule 112 includes a continuous track propulsion system to further reduce compaction. The mule 112 includes a trailer support system 502. The trailer support system 502 is configured to carry and/or transport a trailer 105 from the field to a harvest depository. The trailer support system 502 includes a frame 505, one or more trailer guides 510, and a trailer lift 515. The trailer guides 510 and trailer lift 515 are configured to position the body 405 of the trailer 105 properly on the vehicle 110 for transport. For example, the trailer guides 510 is configured to properly align and position the trailer 105 as the vehicle 110 backs under the trailer 105 and the trailer lift 515 is configured to lift the trailer 105 as needed to enable the vehicle 110 to get into position beneath the trailer 105.

The vehicle 110 further includes a fifth wheel 520, which connects with the kingpin 425 of the trailer 105 to secure the trailer 105 to the vehicle 110. The fifth wheel 520 is configured to move along the trailer guides 510 in order to guide the trailer 105 throughout the hook/drop process. In one example, the trailer lift 515 is actuated via a lift hydraulic system 525. The lift hydraulic system 525 is configured to rotate the trailer lift 515 in the direction shown by arrow 530 to lift the trailer 105. In some examples, the trailer lift 515 is configured to contact the guide rails 430 of the trailer 105 to lift the trailer 105.

Similar to the trailer lift 515, the trailer guides 510 are configured to rotate in the direction shown by arrow 535. The trailer guides 510 include a guide hydraulic system 540 configured to actuate the trailer guides 510. In one example, the mule 112 is an electrically powered autonomous vehicle with a battery 545 serving as a power source. In another example, the mule 112 is powered by an internal combustion type engine.

The vehicle 110 further includes an accessory hitch 550. The accessory hitch 550 is configured to enable the vehicle 110 to hook and/or drop accessories, such as grain baggers, trailers, and/or other accessories. In one embodiment, the accessory hitch 550 includes one or more attachment arms 555 configured to interact with the accessory during a hooking/dropping process.

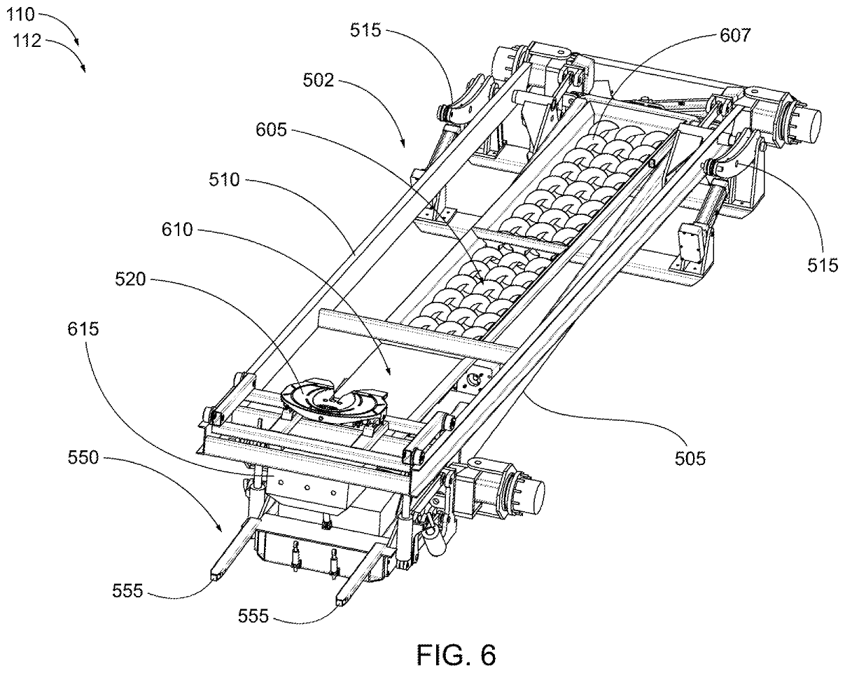

As illustrated in FIG. 6, the vehicle 110 includes a conveyor 605 including one or more conveyor augers 607 configured to transport crops. For example, the conveyor 605 is made up of a series of three (3) side-by-side conveyor augers 607. In other examples, other numbers of conveyor augers 607 are used, such as one (1), two (2), and/or more conveyor augers 607. In another embodiment, the conveyor 605 includes a conveyor belt actuated via one or more rollers. The conveyor 605 is configured to transport crops from the trailer 105 via the conveyor augers 607 through a mule chute 610 and out of a mule hopper 615. As should be appreciated, the conveyor 605 enables the trailer 105 to release the crops from the trailer 105 via the hoppers 415 and automatically deposit the crops into the grain bagger 130 as discussed previously.

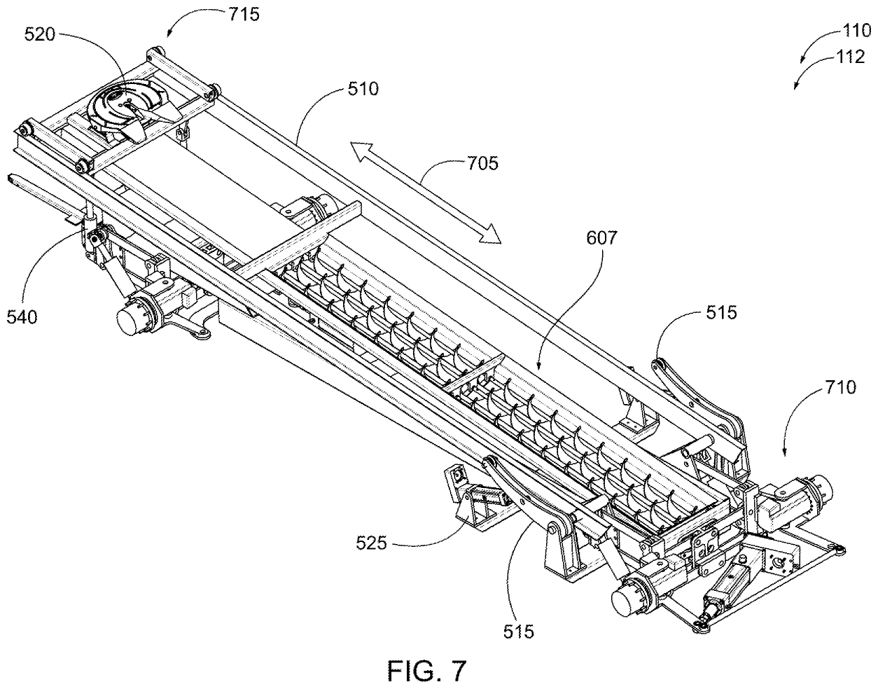

As illustrated in FIG. 7, the fifth wheel 520 is configured to slide along the trailer guides 510 as shown by arrow 705. For example, the fifth wheel 520 is configured to slide along the trailer guides 510 as the vehicle 110 backs under the trailer 105. As should be appreciated, this configuration enables the vehicle 110 and the trailer 105 to be secured together throughout the entire hook/drop process. For example, the fifth wheel 520 begins at a rear end 710 of the mule 112 where the fifth wheel 520 connects with the kingpin 425 of the trailer 105. After the trailer 105 is locked into the fifth wheel 520, the mule 112 begins to back under the trailer 105 such that the trailer 105 is guided onto the mule 112 via the fifth wheel 520. The fifth wheel 520 slides along the trailer guides 510 as shown by arrow 705, towards the front end 715 of the mule 112. After the fifth wheel 520 reaches the front end 715 of the mule 112, the fifth wheel 520 is locked into position to secure the trailer 105 on the mule 112.

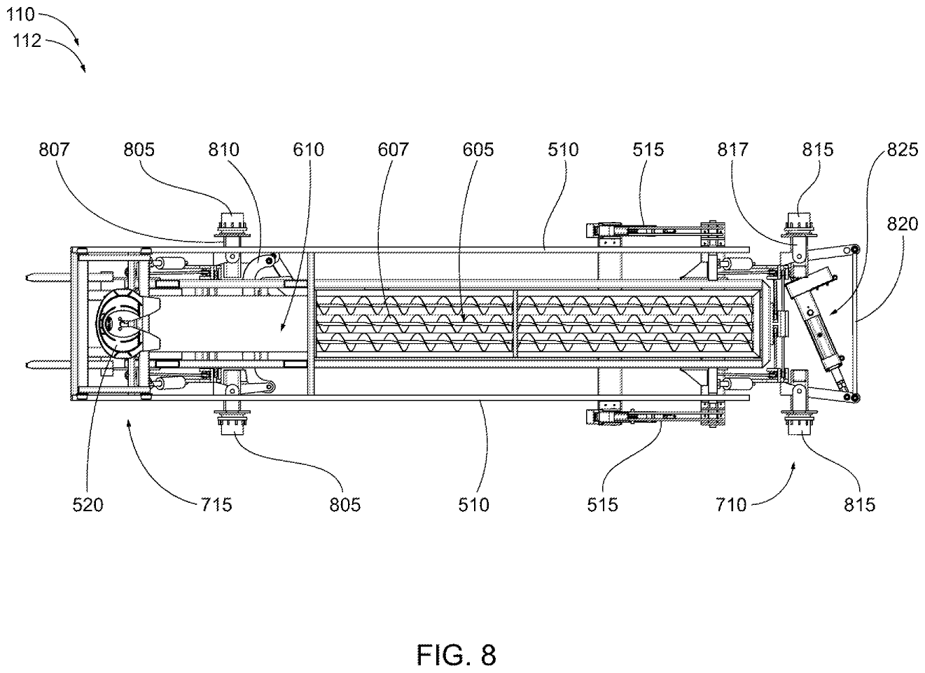

FIG. 8 shows an example of the vehicle 110 without the mule wheels 120 attached. The vehicle 110 includes a pair of front motors 805 mounted on a front axle 807, which are powered via the battery 545. The front motors 805 are steered via a front steering system 810. The vehicle 110 further includes a pair of rear motors 815 mounted on a rear axle 817, which include a rear steering system 820 controlled via a steering hydraulic system 825. In some embodiments, the front motors 805 and rear motors 815 are configured to operate independently of each other. In other examples, the vehicle 110 includes more than two axles, such as three (3), four (4), and/or more axles.

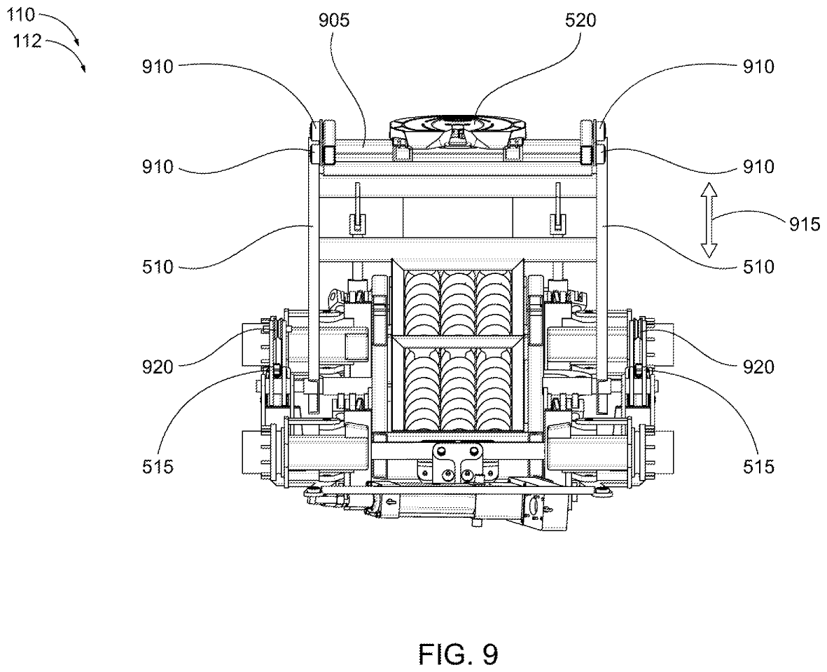

As illustrated in FIG. 9, the fifth wheel 520 is integrated into a plate 905. The plate 905 includes one or more casters 910 configured to enable the fifth wheel 520 to slide along the trailer guides 510 as discussed previously. For example, the fifth wheel 520 is configured to slide along the trailer guides 510 as shown by arrow 915 based on the location of the trailer 105. Additionally, the trailer lift 515 includes one or more rail glides 920. The rail glides 920 are configured to slidably engage the guide rails 430 of the trailer 105 to facilitate loading of the trailer 105 onto the vehicle 110. As should be appreciated, the casters 910 and rail glides 920 are configured to rotate when under pressure from the trailer 105 to lower the friction between the trailer 105 and the mule 112 during loading and/or unloading of the trailer 105.

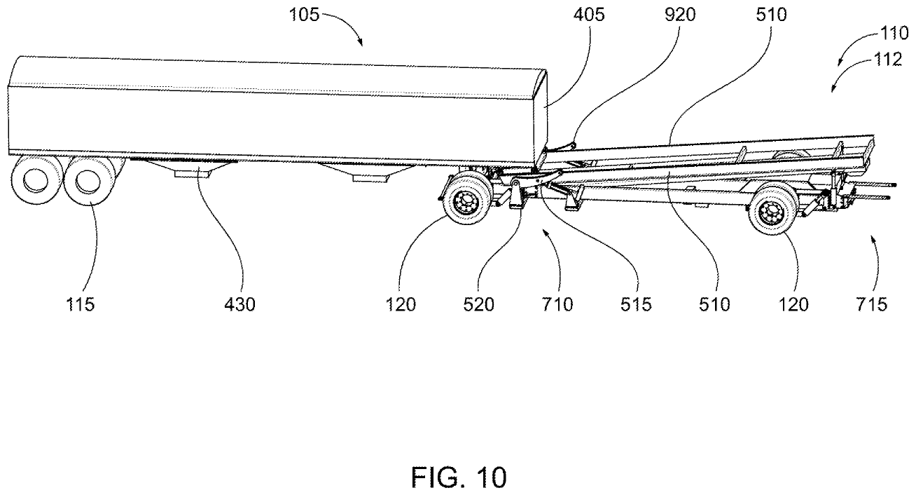

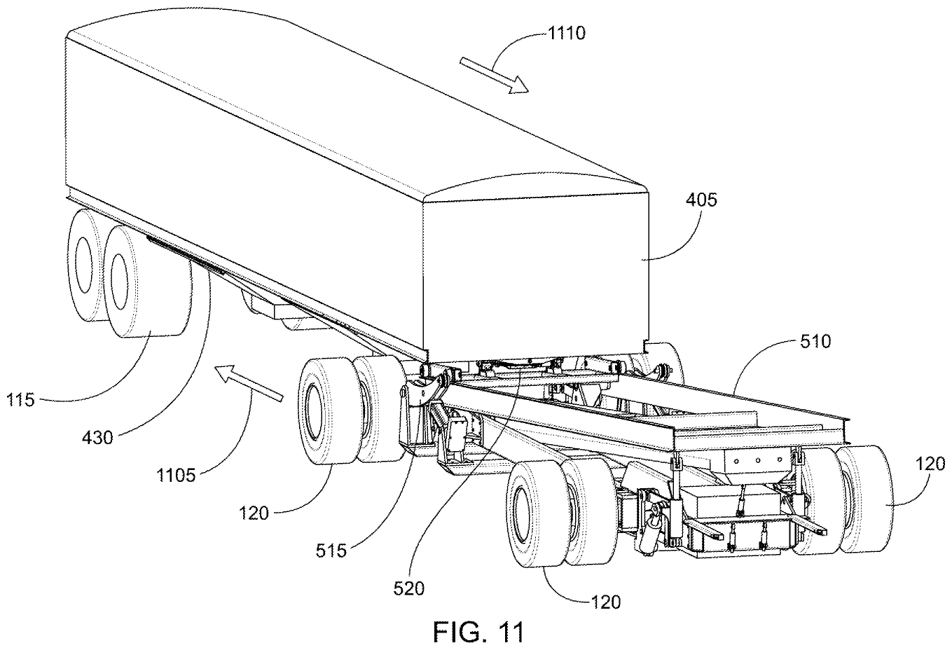

FIGS. 10 and 11 illustrate an example of the trailer 105 being loaded onto the mule 112. During loading, the mule 112 begins by backing under the front of the trailer 105. At this stage, the kingpin 425 of the trailer 105 locks within the fifth wheel 520 at the rear end 710 of the trailer 105. As the vehicle 110 backs further under the trailer 105 as shown by arrow 1105, the fifth wheel 520 slides along the trailer guides 510 as shown by arrow 1110. In some examples, the vehicle 110 sends a command for the trailer 105 to automatically raise the landing gear 420. At this stage, the rail glides 920 of the trailer lift 515 engage the guide rails 430 of the trailer 105. In some examples, the trailer lift 515 is actuated to raise the trailer 105 in order to enable the mule 112 to continue to move under the trailer 105. At this stage, the mule 112 continues to back under the trailer 105 as the fifth wheel 520 slides along the trailer guides 510 towards the front end 715. Once the vehicle 110 is fully under the trailer 105 (see e.g., FIGS. 1, 2, and 3), the vehicle 110 commands the trailer 105 to raise the trailer wheels 115. At this point, the mule 112 supports the entire weight of the trailer 105.

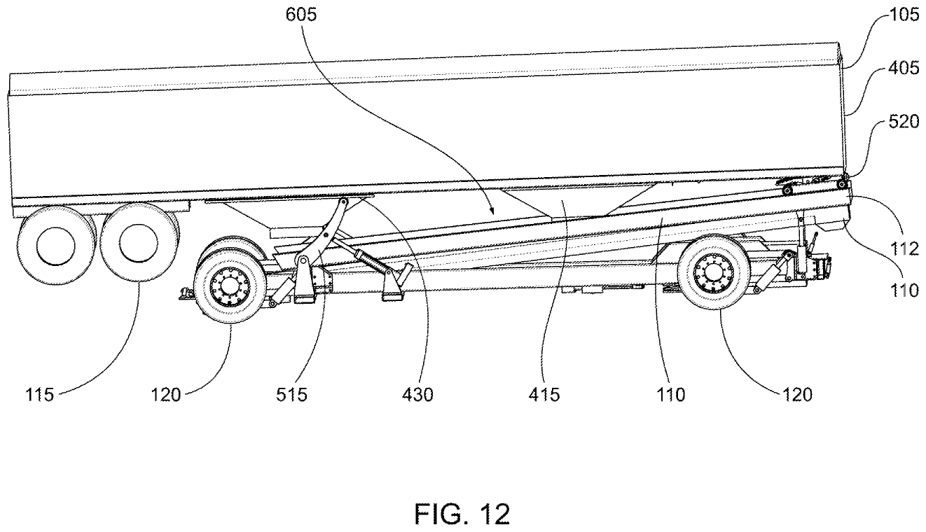

As illustrated in FIG. 12, the trailer 105 is fully secured on the mule 112. Once the mule 112 is fully underneath the trailer 105, the trailer guides 510 rotate such that the trailer 105 is held parallel to the mule 112. In another embodiment, once the mule 112 is fully underneath the trailer 105, the trailer lift 515 rotate upwards to lift the trailer 105 such that the trailer wheels 115 are no longer in contact with the ground. As can be seen, the trailer 105 is aligned on the mule 112 such that the hoppers 415 are aligned with the conveyor 605 of the mule 112. Thus, the hoppers 415 are able to simply open and deposit crops from the trailer 105 onto the conveyor 605 for transport to the grain bagger 130 and/or other storage device.

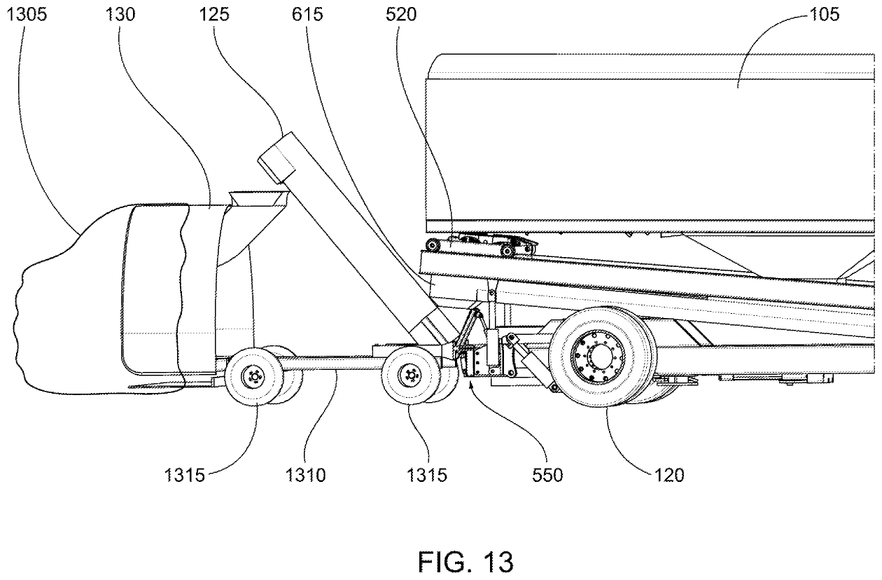

FIG. 13. shows an example of a trailer unloading event. In the trailer unloading event, the vehicle 110 drives to a grain bagger 130. The grain bagger 130 includes a grain bag 1305 and a bag cart 1310 with one or more wheels 1315. In one example, the attachment arms 555 of the accessory hitch 550 are configured to interact with the bag cart 1310 to secure the bag cart 1310 during unloading of the trailer 105. After the grain bagger 130 is secured to the mule 112, the mule 112 commands the trailer 105 to open the hoppers 415. The mule 112 then powers the conveyor 605 to transport crops, such as grain, through the mule chute 610. From the mule chute 610, the grain transfers into the mule hopper 615. After exiting the mule hopper 615, the grain moves through the auger 125 into the grain bag 1305 of the grain bagger 130 for storage. After the trailer 105 is emptied, the mule 112 pulls away from the grain bagger 130, unloads the trailer 105 and picks up a new, full trailer 105.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Brake” generally refers to a device for arresting and/or preventing the motion of a mechanism usually via friction, electromagnetic, and/or other forces. Brakes for example can include equipment in automobiles, bicycles, or other vehicles that are used to slow down and/or stop the vehicle. In other words, a brake is a mechanical device that inhibits motion by absorbing energy from a moving system. The brake can be for example used for slowing or stopping a moving vehicle, wheel, and/or axle, or to prevent its motion. Most often, this is accomplished by friction. Types of brakes include frictional, pressure, and/or electromagnetic type braking systems. Frictional brakes for instance can include caliper, drum, and/or disc drakes. Electromagnetic braking systems for example can include electrical motor/generators found in regenerative braking systems.

“Cellular Device” generally refers to a device which sends or receives data, and/or sends or receives telephone calls using a cellular network. Cellular devices may thus be characterized as nodes in a communications link operating as an originating and/or final receiving node. A cellular device transmits to and receives from a cellular transceiver located in the cell (e.g. at a base unit or “cell tower.”) Radio waves are generally used to transfer signals to and from the cellular device on a frequency that is specific (but not necessarily unique) to each cell. A cellular device may include a computer with memory, processor, display device, input/output devices, and so forth, and thus may be used as, and referred to as, a personal computing device.

“Class 8 Trailer” means, per the U.S. Department of Transportation Heavy Duty Classification, a trailer or trailers pulled behind a truck wherein the gross vehicle weight rating is above 33,000 pounds (14,969 kg).

“Combine” generally refers to a harvesting machine that heads, threshes, and/or cleans grain while moving over a field.

“Computer” generally refers to any computing device configured to compute a result from any number of input values or variables. A computer may include a processor for performing calculations to process input or output. A computer may include a memory for storing values to be processed by the processor, or for storing the results of previous processing. A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network interface to perform various network communications upon request. A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. A computer may include one or more physical processors or other computing devices or circuitry, and may also include any suitable type of memory. A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer. The concept of “computer” and “processor” within a computer or computing device also encompasses any such processor or computing device serving to make calculations or comparisons as part of a disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

“Conveyor” is used in a broad sense to generally refer to a mechanism that is used to transport something, like an item, box, container, and/or SKU. By way of non-limiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“Couple” or “Coupled” generally refers to an indirect and/or direct connection between the identified elements, components, and/or objects. Often the manner of the coupling will be related specifically to the manner in which the two coupled elements interact.

“Fifth-Wheel Coupling” generally refers to a horse-shaped device on a towing vehicle, such as a tractor or truck, that is configured to receive a kingpin on a trailer, such as a semitrailer or camper trailer, so as to provide a mechanical link between the towing vehicle and the trailer. For example, some camper trailers use a fifth-wheel configuration, requiring the fifth-wheel coupling to be installed in the bed of a pickup truck. As the connected truck turns, the downward-facing surface of the trailer with the kingpin at the center rotates against an upward-facing surface of the fixed fifth wheel coupling that does not rotate. To reduce friction, grease is sometimes applied to this surface of the fifth wheel coupling. This fifth-wheel configuration is sometimes called a turn-table in Australia and New Zealand. Typically, but not always, the fifth-wheel coupling is located directly above an axle or between the axles of a vehicle.

“Flat” generally refers to an object having a broad level surface but with little height.

“Frame” generally refers to a structure that forms part of an object and gives strength and/or shape to the object.

“Guidance, Navigation, and Control (GNC) System” generally refers to a physical device, a virtual device, and/or a group of devices configured to control the movement of vehicles, such as automobiles, automated guided vehicles, ships, aircraft, drones, spacecraft, and/or other moving objects. GNC systems are typically configured to determine a desired path of travel or trajectory of the vehicle from the vehicle's current location to a designated target, as well as desired changes in velocity, rotation, and/or acceleration for following the path. The GNC system can include and/or communicate with sensors like compasses, GPS receivers, Loran-C, star trackers, inertial measurement units, altimeters, environmental sensors, and the like. At a given time, such as when the vehicle is travelling, the GNC system is configured to determine the location (in one, two, or three dimensions) and velocity of the vehicle. For example, the GNC system is able to calculate changes in position, velocity, attitude, and/or rotation rates of a moving vehicle required to follow a certain trajectory and/or attitude profile based on information about the state of motion of the vehicle. The GNC system is able to maintain or change movement of the vehicle by manipulating forces by way of vehicle actuators, such as steering mechanisms, thrusters, flaps, etc., to guide the vehicle while maintaining vehicle stability. GNC systems can be found in autonomous or semi-autonomous vehicles.

“Remote” generally refers to any physical, logical, or other separation between two things. The separation may be relatively large, such as thousands or millions of miles or kilometers, or small such as nanometers or millionths of an inch. Two things “remote” from one another may also be logically or physically coupled or connected together.

“Satellite Navigation” generally refers to a system that uses satellites to provide geo-spatial positioning data. In one example, the system may include a receiver that interacts with satellites using electromagnetic radiation. The timing of the transmission of the signal from the receiver to the satellites allows calculation of the position of the receiver using triangulation. Some of examples of satellite navigation systems include global positioning systems such as GPS and GLONASS as well as global positioning systems under development such as Galileo. A satellite navigation system may also be a regional positioning system such as BeiDou, NAVIC, and QZSS.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Short-range communication” generally refers to any network that is capable of transmitting data over short distances using high-frequency electromagnetic radiation. Some of examples of short-range communication protocols include, but are not limited to BLUETOOTH®, Wi-Fi, RFID, and ZigBee.

“Storage Container” generally refers to an object that can be used to hold or transport SKUs or other objects. By way of non-limiting examples, the storage container can include cartons, totes, pallets, bags, and/or boxes.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Tow Coupler” or “Trailer Coupler” generally refers to a device used to secure a trailer, a towed vehicle, and/or other towed object to a towing vehicle. Typically, but not always, the trailer coupler is coupled to a hitch of the towing vehicle. For example, the trailer coupler can be configured to couple to a hitch ball. Common types of trailer couplers include (but are not limited to) straight tongue couplers, A-frame couplers, adjustable couplers, and fifth wheel-gooseneck couplers. The trailer coupler can include any number of mounting styles. By way of non-limiting examples, the mounting styles can include straight channel, foldaway, round tongue, A-frame, flat mount, adjustable tongue, lunette ring, gooseneck, trigger, thumb, wrap around yoke, and pin mounting styles or mechanisms. The trailer coupler in some instances can further include a trailer jack for lifting the trailer coupler to the proper height for coupling to the hitch.

“Tow Hitch”, “Trailer Hitch”, or “Hitch” generally refers to a device attached to a chassis of a vehicle for towing another object, such as a trailer, aircraft, wagon, and/or another vehicle, to name just a few examples. Tow hitches are commonly mounted with bolts or other fasteners to the chassis, but in other examples, the tow hitch can be integrally formed with the chassis and/or attached in other ways such as via welding. Typically, but not always, the trailer hitch is coupled to a trailer coupler that is secured to the towed object. There are a number of types of tow hitches. For example, the tow hitch can include receiver type and fixed drawbar type hitches. Receiver type hitches can include a receiver mounted to the chassis and a removable mount that is connected to the receiver. In one form, the receiver is in the form of a receiver tube that defines a receiver opening in which the removable mount is mounted, such as via a bolt or other fastener, and/or otherwise connected. The removable mount can for example include one or more ball mounts, hitch bike racks, cargo carriers, and/or other hitch mounted accessories. Fixed drawbar type hitches are typically, but not always, built as a unitary piece that is mounted to the chassis. The fixed drawbar type hitch normally includes one or more holes for a trailer ball or other mounts. The trailer mounts can for instance take the form of a tow ball to allow swiveling and articulation of a trailer; a knuckle coupling; a tow pin or a tow hook with a trailer loop coupling; and/or a pintle and lunette ring coupling. The tow hitches can for instance include Society of Automotive Engineers (SAE) class I, II, III, IV, and V hitches.

“Trailer” generally refers to an unpowered vehicle towed by another vehicle. For instance, a trailer can include a nonautomotive vehicle designed to be hauled by road, such as a vehicle configured to transport cargo, to serve as a temporary (or permanent) dwelling, and/or acting as a temporary place of business. Some non-limiting examples of trailers include open carts, semi-trailers, boat trailers, and mobile homes, to name a just few. Typically, trailers lack a power train for propelling themselves over long distances and require another powered vehicle to move them. However, trailers may include a power source, such as a battery or generator, for powering auxiliary equipment.

“Truck” means a powered truck (also known as a tractor or cab) for pulling one or more trailer(s).

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Wall” means here is structure that forms a solid surface. It may be a portion of a house, room, or otherwise. A wall may be planar or multiplanar and may be constructed of any of a variety of materials, including, but not limited to metal, concrete, wood, or plastic.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 harvest transport system
105 trailer
110 vehicle
112 mule
115 trailer wheels
120 mule wheels
125 auger
130 grain bagger
405 body
410 tarp
415 hopper
420 landing gear
425 kingpin
430 guide rails
502 trailer support system
505 frame
510 trailer guides
515 trailer lift
520 fifth wheel
525 lift hydraulic system
530 arrow
535 arrow
540 guide hydraulic system
545 battery
550 accessory hitch
555 attachment arms
605 conveyor
607 conveyor augers
610 mule chute
615 mule hopper
705 arrow
710 rear end
715 front end
805 front motors
807 front axle
810 front steering system
815 rear motors
817 rear axle
820 rear steering system
825 steering hydraulic system
905 plate
910 casters
915 arrow
920 rail glides
1105 arrow
1110 arrow
1305 grain bag
1310 bag cart
1315 wheels

What is claimed is:

1. A harvesting system, comprising:
a trailer; and
a vehicle configured to support the trailer to reduce soil compaction.

2. The harvesting system of claim 1, wherein the trailer configured to collect harvested crops.

3. The harvesting system of claim 1, wherein the trailer is configured to collect harvested crops from a combine.

4. The harvesting system of claim 3, wherein the trailer includes a moisture sensor configured to detect a moisture content of the crops.

5. The harvesting system of claim 1, wherein the trailer has landing gear and a motor configured to automatically extend and retract the landing gear upon detection of the vehicle.

6. The harvesting system of claim 5, wherein the landing gear includes one or more large-footprint pads configured to prevent trailer sinking.

7. The harvesting system of claim 1, wherein the trailer includes one or more retractable wheels.

8. The harvesting system of claim 7, wherein the wheels are configured to retract after the trailer is hooked to the vehicle to reduce compaction.

9. The harvesting system of claim 1, wherein the trailer includes an automatic tarp system configured to open and close based on commands from the vehicle.

10. The harvesting system of claim 9, wherein the trailer includes one or more sensors configured to detect tarp position.

11. The harvesting system of claim 1, wherein the trailer includes a rotating rear door for crop removal.

12. The harvesting system of claim 11, wherein the trailer includes one or more door sensors configured to detect rear door position.

13. The harvesting system of claim 12, wherein the trailer includes a dump hoist for crop removal.

14. The harvesting system of claim 13, wherein the trailer includes an on-board controller configured to monitor the door sensors and tarp sensors to detect load tampering.

15. The harvesting system of claim 1, wherein the trailer includes a Real-time Kinematic Positioning Global Positioning System (RTK GPS).

16. The harvesting system of claim 15, wherein the RTK GPS is configured to use the trailer as a base station for sending real-time corrections to the vehicle.

17. The harvesting system of claim 1, wherein the trailer includes one or more electrically controlled grain hoppers configured to open and close based on commands from the vehicle.

18. The harvesting system of claim 1, further comprising:
a combine; and
wherein the combine includes harvesting machine that heads, threshes, and/or cleans grain while moving over a field.

19. The harvesting system of claim 1, wherein the vehicle is detachably coupled to the trailer to move the trailer.

20. The harvesting system of claim 19, wherein the vehicle includes a hitch.

21. The harvesting system of claim 1, wherein the vehicle is at least a level 4 autonomous vehicle configured autonomously move the trailer to and from a combine.

22. The harvesting system of claim 1, wherein the vehicle is configured to fully support the weight of the trailer to prevent trailer ground contact.

23. The harvesting system of claim 22, wherein the vehicle includes a flat-bed type trailer support system configured to slide beneath the trailer during an autonomous trailer hooking and dropping process.

24. The harvesting system of claim 23, wherein the vehicle and trailer include one or more sensors, channels, and/or rollers configured to facilitate autonomous hooking and dropping of the trailer.

25. The harvesting system of claim 1, wherein the vehicle includes a load sensor configured to detect a loading pattern of crops in the trailer.

26. The harvesting system of claim 1, wherein the vehicle includes a conveyor system configured to receive grain from one or more hoppers and transport grain throughout the vehicle.

27. The harvesting system of claim 26, wherein the vehicle includes an auger configured to automatically transport grain from the conveyor system into a grain bagger.

28. The harvesting system of claim 27, wherein the vehicle and trailer communicate via telemetry to control the automatic hooking and dropping and automatic fill of the grain bagger.

29. A system, comprising:
a harvesting system having a trailer configured to collect harvested crops from a combine and a vehicle detachably coupled to the trailer to move the trailer.

30. A method, comprising:
loading a trailer with harvested crops onto a vehicle;
supporting the trailer with the vehicle to reduce soil compaction;
moving the trailer with the vehicle across farmland; and
unloading the trailer from the vehicle after the moving.
